(19) United States
(12) Patent Application Publication
(10) Pub. No.: US 2010/0090794 A1
(43) Pub. Date: Apr. 15, 2010

(54) A RESISTOR FOR ELECTRIC HIGH-VOLTAGE APPARATUS AND A METHOD OF MOUNTING A RESISTOR

(75) Inventors: Petter Nilsson, Ludvika (SE); David Sundqvist, Ludvika (SE); Lena Lunn, Ludvika (SE)

Correspondence Address: VENABLE LLP, P.O. BOX 34385, WASHINGTON, DC, 20043-9998, US

(73) Assignee: ABB Technology Ltd., Zurich (CH)

(21) Appl. No.: 12/438,753

(22) PCT Filed: Aug. 24, 2007
(86) PCT No.: PCT/SE07/50578

§ 371 Date: Dec. 7, 2009

(30) Foreign Application Priority Data
Aug. 25, 2006 (SE) 0601742-0

(51) Int. Cl. H01C 1/02

(52) U.S. Cl. 338/261

(57) ABSTRACT

A resistor for electric high-voltage apparatus, especially for connection to a diverter switch in an on-load tap changer for a high-voltage transformer. The diverter switch and the resistor are arranged in a housing with transformer oil. The resistor includes a number of resistor elements, wherein each resistor element includes a resistive element, arranged in a frame, which are electrically interconnected by a connection member. The frames are designed to enclose resistive elements that include spring elements formed from spirally wound resistance wire. Connection members include a connection plug. A method of mounting a resistor for electric high-voltage apparatus.

### FIELD OF THE INVENTION

The present invention relates to a resistor for electric high-voltage apparatus, especially for connection to a diverter switch in an on-load tap changer for a high-voltage transformer, wherein the diverter switch and the resistor are arranged in a housing with transformer oil. In this context, high-voltage apparatus means apparatus for tens of kilovolts, up to for example 800 kV and voltages there above.

The invention also relates to a method of mounting such a resistor.

### BACKGROUND ART

A diverter switch included in a tap changer is usually used in connection with a transformer to enable tapping at different voltage levels. This occurs in cooperation with a selector connected to the diverter switch. When the power output from a transformer is to be changed from one voltage level to another, this occurs by first connecting the selector to that tapping point of the transformer winding which corresponds to the new voltage level while the diverter switch is still feeding from the existing voltage level. The connection of the selector thus takes place without current load. When the selector is connected to the tap for the new voltage level, a switching operation takes place with the aid of the diverter switch such that output current is taken out from the new tapping point of the transformer. When a transformer has a plurality of tapping points, switching normally only occurs between two tapping points which are close to each other in terms of voltage. If an adjustment to a more distant location should be required, this takes place step by step. A diverter switch of the kind referred to here is normally used for control of power or distribution transformers. The invention is not, of course, limited to this type of application but may also advantageously be used for control of other types of power transmission or distribution products, such as reactors, phase shifters, capacitors or the like.

The operation of the diverter switch involves commutation from one circuit to another with an ensuing occurrence of an electric arc. To avoid polluting the insulating medium, such as oil, into which the diverter switch is normally immersed, and to reduce the wear of the switch contacts, it is previously known to use vacuum switches for those switching operations where an arc arises. The electrical contact wear will then only arise in the vacuum switch. For an appropriate procedure from an electrical point of view, a diverter switch of this kind is provided with at least one main branch and one resistance branch. Heavy demands are placed on the resistors in such a resistance branch, for the following reasons.

The resistor in an on-load tap changer is connected for a very short period of time in the normal operating position, for example for a period of between 20 and 50 ms. During this time, however, the current that passes through the resistor elements in the resistor is considerable. For example, amperages of up to 2000 A may be achieved as well as a step voltage of 4.5 kV. It is thus required that the resistor wire for a short period may absorb a large energy mass in the form of heat, since it is realized that during the short switching operation the heat is not capable of being dissipated to any greater extent outside the resistor, since the cooling takes place substantially through the passage of oil after the actual switching operation.

Thus, the amount of heat that a resistor element may instantaneously accumulate is, among other things, dependent on the amount of resistance material in the resistor. An example of a dimensioning capacity is a heat-absorption capacity of between 80 J/g and 100 J/g resistance material. An example of resistance material is CuNi44.

The modes of operations of the tap changer are described in greater detail in PCT publication WO 2006/004527 and PCT patent applications WO SE2006/050552 and WO SE2007/050187.

Resistors for tap changers are also known from, for example, GB 1483003 and DE 2220111.

The present invention seeks to provide an improved resistor with regard to capacity, compactness, flexibility (modular design), capacity of being mounted, and reliability of service.

The invention also seeks to provide a method of mounting a resistor in a cost-effective manner.

### SUMMARY OF THE INVENTION

According to an aspect of the invention there is provided a resistor of the kind described in the preamble to claim 1 by arranging the frames so as to enclose resistor elements, which comprise spring elements formed from spirally wound resistance wire. In this way, the entire circumference of the resistance wire is surrounded by the oil in the channel and the instantaneous heating of the wire occurs uniformly since the whole surface of the resistance wire is in direct contact with the oil. Together with the subsequent effective cooling, this contributes to the high capacity of the resistor according to the invention, which is rapidly cooled down after each switching operation. By designing the resistor element in the form of spring elements, the further advantage is obtained that the length of resistance wire in the spring element may be made large. At the high voltages to which the present invention relates, the distance between the top part of the resistor and the top part of the housing, that is, the distance insulated by the oil, must be sufficient to ensure the necessary electrical insulation.

The transition resistances constitute the highest energized point, in the vertical direction, of the diverter switch. The shape of the resistor element in the form of a spring element according to the invention further provides a uniform electric field, where high field concentrations are prevented, whereby the invention eliminates the need of a separate, so-called shield ring.

Other aspects of the invention are described by means of embodiments according to the appended subclaims.

According to one embodiment, the resistor comprises one resistor module for each phase, the frame exhibits a number of mutually isolated, parallel and open channels, said channels being arranged to enclose the spring elements formed from spirally wound resistance wire, and within a resistor module a number of resistor elements are stacked on top of each other thus forming an integrated unit, wherein each channel in a resistor element with the corresponding channels in adjacent resistor elements forms a substantially open channel. This results in a compact design of the resistor module and the resistor, which is thus advantageous from several points of view. Further, the retaining open channels through the whole resistor module makes possible an efficient circulation of the oil through the channels, among other things through the “chimney effect” that arises.

According to one embodiment, the frame is designed with a number of longitudinal parallel walls, forming outer walls and inner walls, which are connected at their respective ends to transverse short walls forming said channels, one longitudinal edge of said walls exhibiting protruding spacers which are connected to transverse bars, whereby said spacers towards adjacent resistor elements form longitudinal gaps open towards the channels. The bars thus serve as support for the spring elements in the channels and ensure that the spring elements, which are located respectively over and under each other in the channels in the resistor, do not make mechanical contact with each other, but that the insulating distance between the spring elements is ensured. At the same time the spacers form open gaps between the resistor elements, which essentially contributes to the oil circulation within the resistor.

According to one embodiment, one end of each inner wall is formed with at least one recess arranged at the opposite end in relation to the recess at the adjacent inner wall, in which recesses bridging wire elements are arranged for electrical connection of the spring elements within the respective frame. This minimizes the number of recesses while at the same time it is ensured that the spring elements within one frame may be connected electrically in series through said wire elements.

According to one embodiment, the spring elements and the wire elements within the respective frame forming the resistor element consist of an integrated unit. This results in an advantageous mechanical locking of the spirally-wound spring elements in the respective channel after they have been pressed down with low pressure into the respective channels. Since the longitudinal walls, at their sides which are open to the channel, are somewhat resilient, the width of the channel may increase somewhat when the spring element is pressed down into the channel. The spiral design of the spring element also allows for the spring element to be somewhat extended at the points where the bulges are arranged.

According to one embodiment, the outer walls and the side walls along the open side of the respective channel comprise wart-like bulges that are arranged to lock the spirally wound spring elements in their respective channels.

According to one embodiment, the frames are formed with guide members in the form of guide pins and corresponding guide holes for fixing adjacent resistor elements to each other. These contribute to fixing adjacent resistor elements to each other in the lateral direction.

According to one embodiment, the short walls at one end of the outer channels are formed with a recess for a connection member to the spring element, and the outer channels in the frame at one end are formed with a recess for a connection member to the spring element. This provides an opening for applying connection members within the height of the frame and direct towards the end of the spring element, which there exhibits an annular cavity.

According to one embodiment, the recesses for the connection members are diametrically arranged and each frame comprises an odd number of channels. This means that the resistor elements may be formed such that, when being mounted to the resistor module, they may be turned so as to face in either direction in the plane.

According to one embodiment, the number of channels is between 3 and 7, preferably 5. In this way, the necessary quantity of resistance wire may be applied in each resistor element while at the same time the width of the resistor module and hence also the resistor may be limited.

According to one embodiment, the frame is made of an injection-moulded electrically insulating plastic material.

This makes possible a cost-effective manufacture of the frame while at the same time the mechanical and electrical properties of the material are advantageous in this context.

According to one embodiment, the resistance wire consists of CuNi44. This results in the advantage of obtaining a resistor with high-quality resistance material with documented properties.

According to one embodiment, the number of resistor elements forming a resistor module is an even number. This results in the advantage that the external connection to the resistor module will always be on the same side.

According to one embodiment, the resistance elements of the resistor elements within the resistor module are series- and/or parallel-connected. This results in great flexibility for achieving a resistor with the desired electrical performance by the choice of connection between the resistor elements.

According to one embodiment, the resistor comprises three resistor modules for a three-phase system. Here, three modules are arranged in parallel and adjacent each other forming a compact integrated unit.

According to one embodiment, the spiral spring element is connected to a connection member that comprises a connection plug that is formed with a thread-formed contact part and a flange part, said contact part being arranged to be screwed, with a rotary motion, into the spiral spring element, said flange part being configured to be mechanically fixed to the frame. In this way, among other things, a fast, simple, cost-effective and safe mounting of the connection member to the spring element is obtained, without any soldering being required. Further, a possibility of non-destructive dismantling of the connection device is provided.

According to one embodiment, the flange part is provided with a threaded bore, and an electrically conductive foil is arranged, with a screw in the threaded bore of the connection plug, to be brought into electrical contact with and be mechanically locked to the connection plug. This results in a fast and efficient locking with good electrical contact between the parts.

According to one embodiment, the thread-shaped contact part is formed with a screw pitch which somewhat exceeds the pitch of the spiral spring element in a mechanically unloaded state, whereby, during mounting, the resistance spring is stretched within that part of the spring element that surrounds the contact part. In this way, the spring element is stretched when being screwed in, and the spring force contributes to provide a high friction between the parts, in which case it is ensured that the risk of play between the connection plug and the spring element is minimized.

According to one embodiment, the connection plug is arranged to be connected to the spring element formed from resistance wire consisting of CuNi44. In this way, a resistor with a high-quality resistance material with documented properties is obtained.

The invention is also directed to a method of mounting a resistor as described in the preamble of claim 20, whereby the mounting comprises the following steps:
resistive elements in the form of an integrated unit comprising spring elements formed from spirally wound wire with two connection ends are applied to the frame in channels provided there for,
connection plugs are screwed into the two connection ends of the spring element, and flange parts arranged at the connection plugs are placed and fixed mechanically in recesses provided there for in the frame,
the resistor elements forming a resistor are stacked on top of each other,
the resistor elements are mounted on the electric apparatus and are locked mechanically to the electric apparatus,
the resistive elements in the resistor elements are connected electrically by means of a connection foil, which bridges the distance to adjacent resistor elements, are screwed into bores arranged at the ends of the connection plugs, whereby the resistive elements in all the resistor elements are connected electrically to each other, both in parallel and in series,
the remaining connection end of the respective two outer resistor elements is connected in a corresponding way to the connection device of the electric apparatus.

In this way, a fast and cost-effective mounting of the resistor is obtained, and the mounting may be made very flexible since resistors with different capacities may be mounted on the same resistor element, the number of which is varied according to the need. Also, it is simple to connect the resistor elements internally in series or in parallel, and it is easy, where necessary, to replace a resistive element in one frame by a resistive element with a different electrical capacity (resistivity and volume of resistance material, respectively).

### BRIEF DESCRIPTION OF THE DRAWINGS

The invention will be described in greater detail by description of embodiments with reference to the accompanying drawings, wherein

FIG. 1 is a perspective view of three resistor modules (one for each phase) according to an embodiment of the invention, mounted as one of the components included in a tap changer, which are intended to be surrounded by a tap changer housing,

FIG. 2 is a perspective view of a resistor element constituting part of the resistor module forming the resistor according to the invention,

FIG. 3 schematically shows units included in a resistor element, such as a frame with channels, resistive elements and connection plugs,

FIG. 4 is a view of a resistor element as seen from the open side of the channels,

FIG. 5 is a view of a resistor element as seen from the side opposite to the side in FIG. 4,

FIG. 6 is a side view of a resistor element as seen from its long side according to FIG. 5,

FIG. 7 is an end view of a resistor element as seen from left-hand side shown in FIG. 6,

FIG. 8 is a side view of a resistor module composed of six resistor elements stacked on top of each other,

FIG. 9a schematically shows a side view of the resistor module as seen from its left-hand side shown in FIG. 8,

FIG. 9b schematically shows a side view of the resistor module as seen from its righthand side shown in FIG. 8,

FIG. 10 shows a connection plug in a perspective view,

FIG. 11 is an end view of the connection plug with a bore,

FIG. 12 shows a longitudinal section of the connection plug.

### DESCRIPTION OF THE PREFERRED EMBODIMENTS

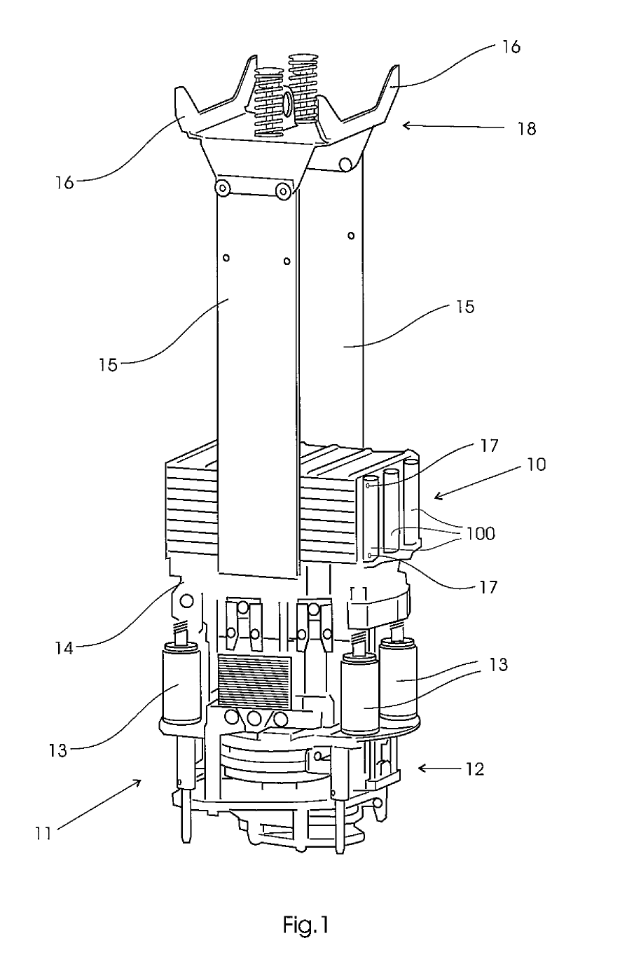

FIG. 1 shows a resistor 10 according to the invention mounted in a tap changer for three phases. The resistor 10 shown in the figure comprises three resistor modules 100, one for each phase. The details of the tap changer will not be described in detail here, but it may be mentioned that it comprises, inter alia, a mechanical drive mechanism 12 with a mechanical energy-storage system that drives the diverter switch 11 in the tap changer. These units and their function are described in more detail in patent publication WO2006/004527 and in PCT patent applications WO SE2006/050552 and WO SE2007/050187.

The above units form a unit that is mounted on a frame structure 14, which in turn is integrated with two beams 15, arranged in parallel and made of an electrically insulating material. At their upper parts the beams are connected to lifting means 16. During mounting, the entire unit is lowered down into a tap changer housing (not shown here), which is filled with transformer oil. The function of the oil is partly to cool the units and partly to function as an electric insulator as well as for lubrication of the mechanically movable components.

The resistor 10 according to the invention is arranged between said beams 15 and rests on the upper side of the frame structure 14 and there forms a compact integrated unit. In a three-phase tap changer, three resistor modules 100 are arranged adjacent to each other, one for each phase. Each resistor module 100 is provided with two connections 17, each being connected to the respective vacuum switch 13, as is described in more detail in the above WO 2006/004527.

When the tap changer is connected to control the voltage of a high-voltage transformer, the voltage may amount to tens of kV, up to 800 kV and more. The electric components in the tap changer lie at said high potential whereas the components on the top part of the housing are at ground potential.

At the high voltages to which the present invention relates, the distance between the top part of the resistor 10 and the top part 18 of the housing, that is, the distance insulated by the oil, must be sufficient to ensure the necessary electrical insulation. Since according to the invention each resistor module 100 comprises a number of resistor elements 101 stacked on top of each other, forming an integrated unit, a compact design of the resistor module 100 and the resistor 10 is obtained, which is thus advantageous. The transitions resistances constitute the highest energized point in the diverter switch in the vertical direction. The shape of the resistive elements 102 in the form of a spring element 105 provides an even electric field, where high field concentrations are prevented. In this way, the need of a separate so-called shield ring is eliminated.

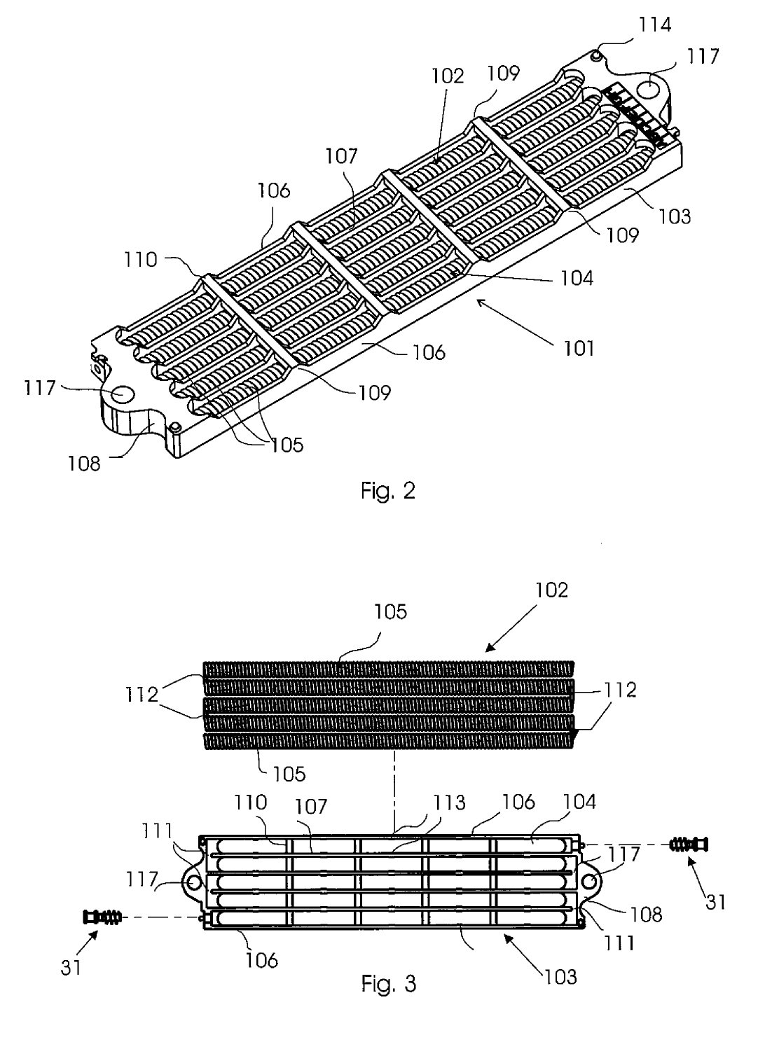

FIG. 2 is a perspective view of a resistor element 101 constituting part of the resistor 100, the resistor module 100, according to the invention. According to the invention, each resistor element 101 comprises a resistive element 102 arranged in a frame 103, said resistive elements 102 being electrically interconnected by means of connection members, as will be clear from FIGS. 9a and 9b.

The frame 103 exhibits a number of mutually insulated, parallel and open channels 104, which are configured to enclose a spring element 105 formed from spirally wound resistance wire. By designing the resistive element 102 in the form of spring elements 105, the advantage is achieved, among other things, that the length of resistance wire in each spring element 105 may be made long, while at the same time the spring element per se becomes compact. Examples of dimensions are an outer diameter of the spring element of 12 mm and a wire diameter of 2.5 mm. The outer diameter of the spring element 105 is adapted to the channels 104 in the frame 103.

As further example, a resistor module 100 according to one embodiment is formed with five parallel rows of spring elements 105, each having a length of about 300 mm and may contain, depending on the wire thickness, between 13 and 16 m of resistance wire. The spiral spring element further exhibits a good permeability to the oil and has only point contacts with the frame, which is essential for the cooling function.

As is further clear from FIG. 2, the frame 103 according to the invention is formed with a number of longitudinal parallel walls 106, 107, forming outer walls 106 and inner walls 107, joined at their respective ends to transverse short walls 108. The short walls 108 thus delimit the channels 104 in the longitudinal direction. The walls 107 also serve as electrical insulation of the spring elements 105 in the plane adjacent to the channels 104.

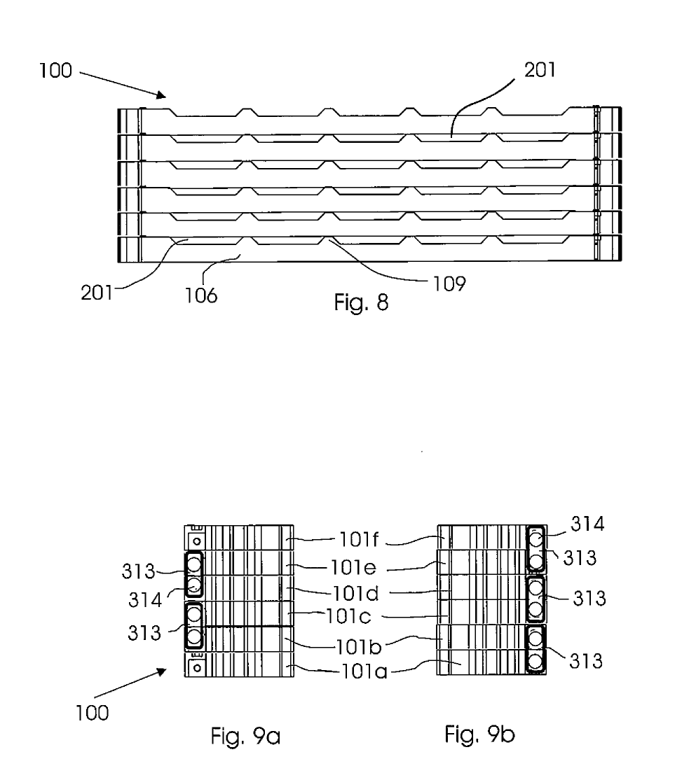

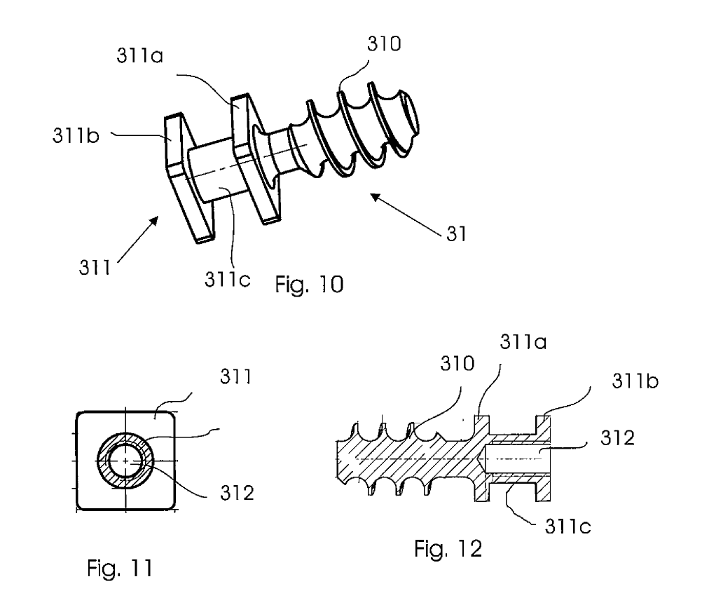

It is realized that when the resistor elements 101 are mounted on top of each other (as is clear from FIGS. 8 and 9a, 9b), each channel 104 in a resistor element 101 will be located over a corresponding channel 104 in the underlying resistor element 101, thus forming substantially open parallel channels through the whole resistor module 100. Together with the spring element 105 that is permeable to oil, efficient circulation of the oil through the channels 104 is allowed, among other things by the “chimney effect” that arises.

The resistor 10 in a tap changer is switched in for a very short period of time during a normal operating mode, for example for a period of time of between 20 and 50 ms. During this time, however, the current that passes through the resistive elements 102 is large. For example, amperages of up to 2000 A and a step voltage of up to 4.5 kV may be achieved. Thus, it is required that the resistance wire for a short period may absorb a large energy mass in the form of heat as it is realized that, during the short switching operation, the heat will have no time to be diverted to any greater extent outside the resistor, since the cooling takes place substantially through passage of oil after the actual switching operation.

The amount of heat that a resistive element may instantaneously accumulate is thus, among other things, dependent on the amount of resistance material in the resistor. An example of a dimensioning capacity is a heat-absorption capacity of between 80 J/g and 100 J/g of resistance material. An example of a resistance material is CuNi44.

Because of the invention, the entire circumference of the resistance wire is surrounded by the oil in the channel and the instantaneous heating of the wire takes place uniformly since the entire surface of the resistance wire is in direct contact with the oil. This fact, and the subsequent efficient cooling, contributes to the high capacity of the resistor according to the invention, which is rapidly cooled down after each switching operation.

As will be clear from FIG. 2, one of the longitudinal edges of the walls 106, 107 is provided with protruding spacers 109, which in turn are interconnected by transverse bars 110. The bars 110 serve as support for the spring elements 105 in the channels 104 and ensure that the spring elements 105, which are located respectively above and below each other in the channels 104 in the resistor, do not make mechanical contact with each other but that the insulating distance between the spring elements 105 is ensured.

The spacers 109 at the same time form open gaps 201 between the resistor elements, as is clear from FIG. 8. These gaps 201 contribute to the oil circulation within the resistor module.

As is clear in more detail from FIG. 3, each inner wall 107 is formed at one end with a recess 111 where bridging wire elements 112 are arranged for electrical connection of the spring elements 105 within the respective frame 103. According to one embodiment, each recess 111 is arranged at the opposite end in relation to the recess 111 at the adjacent inner wall 107 to minimize the number of recesses, while at the same time it is ensured that the spring elements 105 within a frame 103 may be connected electrically in series by means of said wire elements 112.

According to one embodiment, the resistive element 102 in a frame 103 is constituted by an integrated unit of the spring elements 105 and the wire elements 112, as is shown in FIG. 3.

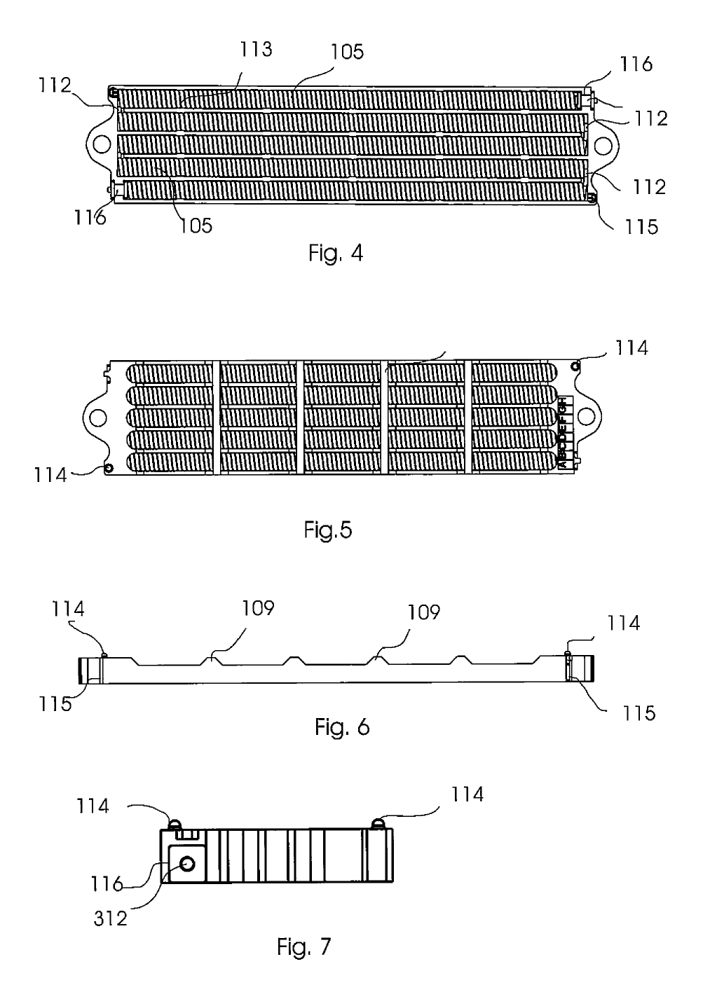

By providing the outer walls 106 and the side walls 107 along the open side of the respective channel 104 with wart-like bulges 113, according to one embodiment shown in FIGS. 3 and 4, an advantageous mechanical locking of the spirally wound spring elements 105 in the respective channel 104 is obtained, after the spring elements have been pressed down with low force in the respective channel 104. Since the longitudinal walls 106, 107, at their sides open to the channel, are somewhat resilient, the width of the channel 104 may increase somewhat when the spring element 105 is pressed down into the channel 104. The spiral spring design of the spring element 105 also allows the spring element 105 to be extended somewhat at the points where the bulges 113 are arranged.

By one embodiment, the frames 103 are formed with guide members in the form of guide pins 114, shown in FIGS. 2, 5 and 6, and guide holes 115 adapted to the guide pins, as will be clear from FIG. 4. The guide members 114, 115 contribute to fixing adjacent resistor elements 101 to each other in the lateral direction.

Additional guiding and locking of the resistor blocks to each other and to the frame structure 14 in the tap changer occur by bolt joints (not shown) running through bolt holes 117 provided in the frames.

According to one embodiment, the outer channels 104 in the frame 103 are formed, at one end, with a recess 116 for a connection member to the spring element 105, which is clear, inter alia, from FIGS. 3 and 7. The connection members 30 will be described in more detail below. Suitably, these recesses 116 are diametrically arranged in the frames 103 when these comprise an odd number of channels 104, which means that the resistor elements 101 may be formed so that, when being mounted to the resistor module 100, they may face in either direction in the plane. Suitably, the number of channels 104 in a frame is between 3 and 7, preferably 5. This embodiment makes it possible to apply a sufficient quantity of resistance wire in each resistor element 101 while at the same time the width of the resistor module 100 and hence also the resistor 10 may be limited.

According to one embodiment, the frame 103 is made of an electrically insulating material, preferably of a plastic material that is suited for compression moulding, which is favourable from the point of view of manufacture.

According to one embodiment, the number of resistor elements 101 forming a resistor module 100 is an even number, suitably a number between 2 and 12. In case of resistors for very high voltages, the number of resistor elements 101 may be considerably higher. Since the number is even, the two outer connections of the resistor module to the electric apparatus will be on one short side of the resistor module 100, as shown in FIG. 9a. The resistor module 100 in the figure comprises six resistor elements, designated from 101a to 101f. The lowermost resistor element 101a and the uppermost resistor element 101f comprise recesses 116 for the external connections 17 of the module, which recesses are intended to be connected to the electric apparatus whereas the other recesses 116 are intended for internal connection of the resistive elements 102 within the resistor module.

On the short side of the resistor module according to FIG. 9a, the resistor elements 101b and 101c as well as 101d and 101e are electrically interconnected by foils 313.

Correspondingly, at the other short side of the resistor module according to FIG. 9b, the resistor elements 101 are electrically interconnected between the resistor elements 101a and 101b, 101c and 101d as well as 101e and 101f. In this way, all the resistive elements 102 in the resistor will be series-connected, but it is realized that a corresponding parallel connection of the resistive elements within a resistor module 100 is within the scope of the invention without this having to be described in more detail here.

The invention also relates to a connection member 30 in a resistor according to the above. As previously mentioned, the resistance wire consists of CuNi44. This material is relatively hard, which implies that brazing with a silver solder is the normal manner of connecting connections to the material. However, soldering is a very time-consuming and costly process from the material point of view. It also entails considerable difficulties to connect the resistance wire to connections, using some form of clamping joint, because of the hardness of the resistance material.

As is clear, among other things, from FIGS. 3, 11 and 12, according to one embodiment the connection member 30 thus comprises connection plugs 31, which are formed with a threaded contact part 310 and a flange part 311, where the contact part 310 is arranged to be screwed, with a rotary motion, into the end of the spiral spring element 105 and the flange part 311 is designed to be mechanically fixed into the recess 116.

According to one embodiment, the flange part 311 of the connection plug 31, at its end opposite to the contact part 310, is provided with a threaded bore 312. An electrically conductive foil 313, shown in FIGS. 9a and 9b, is arranged, by means of a screw 314, to be brought into electrical connection and be mechanically locked to the connection plug.

According to one embodiment, the threaded contact part 310 is formed with a pitch that somewhat exceeds the pitch of the spiral spring element in a mechanically unloaded state, whereby, during mounting, the resistance spring is stretched within that part of the spring element which surrounds the contact part 310.

The spring force together with the friction between the threaded contact part ensures that the risk of a play between the connection plug 31 and the spring element 105 is minimized.

It is realized that the mechanical and electrical contact of the contact plate 313 to the connection plug 31 may be additionally ensured by applying a locking washer (not shown) between the screw 314 and the foil 313.

According to one embodiment, the flange part 311 of the connection plug 31 is formed with two flanges 311a and 311b with an intermediate spacer 311c, which is formed with a rectangular cross section, the width of which is somewhat smaller than the width of the recess 116 arranged in the frame, which provides the advantage that when the connection plug 31 is applied in the recess it is locked for rotation whereas the two flange parts 311a and 311b, which are located on respective sides of the short wall 108 at the recess 116, lock the plug in the longitudinal direction. Taken together, this facilitates the mounting and fixing of the connection plug 31 to the spring element and to the frame, as well as the mounting of said foil 313 with said screw 314. Also the square-shaped flanges 311a and 311b contribute to locking against rotation in that they are supported against the edge in the recess 116 in the frame 103.

The invention also relates to a method of mounting a resistor 10 for electric high-voltage apparatus, especially for connection to a diverter switch in a tap changer for a high-voltage transformer of the kind described above.

According to one embodiment, the mounting operation according to the invention comprises the following steps:
resistive elements 102, comprising an integrated unit including spring elements 105 formed from spirally wound resistance wire, which are interconnected by means of bridging wire elements 112, are applied to the frame 103 in channels 104 provided there for,
the connection plugs 31 are screwed into both connection ends of the spring element 105 and the spacer 311c arranged between the flanges is placed in the recesses 116 in the frame 103,
the resistor elements 101 are stacked on top of each other so that the guide pins 114 are brought into locking position in the guide holes 115, for forming a resistor module 100,
the resistor modules 100 are mounted on the electric apparatus in the frame structure 14 and are locked mechanically to the electric apparatus with the aid of a bolt joint,
the resistive elements 102 in the intermediate resistor elements 101 are connected electrically in that the connecting foils 313, which bridge the distance to the adjacent resistor element 101 and electrically connect these to each other, are screwed into the threaded bore holes 312 arranged at the ends of the connection plugs 31, so that the resistive elements 102 in all the resistor elements 101 within one resistor module 100 are electrically connected to each other, in parallel or in series, and that
the remaining connection ends of the respective two outer resistor elements 101a, 101f are connected in a corresponding manner, with the aid of connection plugs 31, to the connections 17 of the electric apparatus.

It is realized that the mounting need not be performed exactly according to the order of these individual steps but that certain steps may be made in a different order within the scope of the invention. The connection plugs 31 may, for example, be mounted to the spring elements 105 before these are placed in the channels 104, and the resistor elements 101 for the respective resistor module 100 may be mounted direct onto the bolts of the bolt joint, or the internal connection of the connecting foils 313 within a resistor module 100 may take place before this module is mounted on the bolt joint.

In those cases where the resistor comprises several resistor modules 100, these may be mounted together to form a resistor 10 before being placed on the frame structure 14.

Further, the invention is not limited to the described and shown embodiments, but the person skilled in the art may, of course, modify it in a number of ways within the scope of the invention as defined by the claims.

1. A resistor for electric high-voltage apparatus, said resistor comprising:
a number of resistor elements, wherein each resistor element comprises a resistive element arranged in a frame, the resistive elements comprising spring elements comprising spirally wound resistance wire; and
a connection member operative to connect said resistive elements in the resistor elements, wherein the frames are designed to enclose the resistive elements.

2. The resistor according to claim 1, further comprising:
one resistor module for each phase, wherein the frame comprises a number of mutually insulated parallel and open channels, said channels being configured to enclose the spring elements formed from spirally wound resistance wire, wherein within a resistor module a number of resistor elements are stacked on top of each other forming an integrated unit, wherein each channel in a resistor element with the corresponding channels in adjacent resistor elements forms a substantially open channel.

3. The resistor according to claim 2, wherein the frame is formed with a number of longitudinal parallel walls, forming outer walls and inner walls, joined at the respective ends to transverse short walls forming said channels, one of the longitudinal edges of said walls exhibiting projecting spacers which are interconnected by transverse bars, whereby said spacers towards adjacent resistor elements form longitudinal gaps which are open towards the channels.

4. The resistor according to claim 3, wherein each inner wall, at one end, comprises at least one recess arranged at the opposite end in relation to the recess at the adjacent inner wall, in which recesses bridging wire elements are arranged for electrical connection of the spring elements within the respective frame.

5. The resistor according to claim 1, wherein the spring elements and the wire elements within the respective frame forming the resistive element comprise an integrated unit.

6. The resistor according to claim 3, wherein the outer walls and the side walls along the open side of the respective channel comprise wart-like bulges, which are configured to lock the spirally wound spring elements in the respective channel.

7. The resistor according to claim 1, wherein the frames are formed with guide members in the form of guide pins and corresponding guide holes for fixing adjacent resistor elements to each other.

8. The resistor according to claim 3, wherein the short walls at one end of the outer channels are formed with a recess for a connection member to the spring element.

9. The resistor according to claim 8, wherein the recesses for the connection members are diametrically arranged, and wherein each frame comprises an odd number of channels.

10. The resistor according to claim 2, wherein the number of channels is between three and seven.

11. The resistor according to claim 1, wherein the frame comprises an injection-moulded electrically insulating plastic material.

12. The resistor according to claim 1, wherein the resistance wire comprises CuNi44.

13. The resistor according to claim 2, wherein the number of resistor elements forming a resistor module is an even number.

14. The resistor according to claim 1, wherein the resistive elements of the resistor elements within the resistor module are series- or parallel-connected.

15. The resistor according to claim 2, wherein the resistor comprises three resistor modules for a three-phase system forming an integrated unit.

16. The resistor according to claim 1, wherein the spiral spring element is connected to a connection member, said connection member comprising a connection plug which is formed with a threaded contact part and a flange part, said contact part being arranged to be screwed, with a rotational movement, into the end of the spiral spring element, and wherein the flange part is designed to be mechanically fixed in the recess of the frame.

17. The resistor according to claim 16, wherein the flange part is provided with a threaded bore, and wherein an electrically conducting foil is configured to be brought into electrical contact with and be mechanically locked to the connection plug by a screw in the threaded bore of the connection plug.

18. The resistor according to claim 16, wherein the threaded contact part comprises a pitch thread that exceeds the pitch of the spiral spring element in the mechanically non-loaded state, whereby, during mounting, the resistance spring is stretched within a part of the spring elements which surrounds the contact part.

19. The resistor according to claim 13, wherein the connection plug is configured to be connected to the spring element formed from resistance wire consisting of CuNi44.

20. A method of mounting a resistor for electric high-voltage apparatus, said resistor comprising a number of resistor elements, wherein each resistor element comprises a resistive element arranged in a frame, said resistive elements in the resistor elements being electrically interconnected by a connection member, the method comprising:
applying to the frame in channels provided therefor resistive elements comprising an integrated unit comprising spring elements formed from spirally wound wire with two connection ends,
screwing connection plugs into the two connection ends of the spring element, and
placing and mechanically fixing in recesses provided therefor in the frame flange parts arranged at the connection plugs,
stacking on top of each other the resistor elements forming a resistor,
mounting the resistor elements on the electric apparatus,
mechanically locking the resistor elements to the electric apparatus,
electrically connecting the resistive elements in the resistor elements with a connection foil, which bridges the distance to adjacent resistor elements,
screwing the resistive elements into bores arranged at the ends of the connection plugs, whereby the resistive elements in all the resistor elements are connected electrically to each other, both in parallel and in series, and
connecting the remaining connection end of the respective two outer resistor elements in a corresponding way to the connection device of the electric apparatus.
